(19) United States
(12) Patent Application Publication
(10) Pub. No.: US 2024/0087429 A1
(43) Pub. Date: Mar. 14, 2024

(54) PORTABLE AIR HORN APPARATUS AND METHOD FOR OPERATING THEREOF

(71) Applicant: Yurii Velihosha, Granada Hills, CA (US)

(72) Inventor: Yurii Velihosha, Granada Hills, CA (US)

(21) Appl. No.: 18/512,277

(22) Filed: Nov. 17, 2023

(51) Int. Cl. G08B 3/06; G10K 9/04

(52) U.S. Cl. CPC G08B 3/06; G10K 9/04

(57) ABSTRACT

An apparatus includes a housing; an air horn assembly for generating a warning sound, said air horn being mounted on said housing and receiving a pressurized air from an air pump, said air pump being operable by an electric motor; a power source; a switch for selectively operating said electric motor using said power source; an electrical relay for selectively operating said electric motor using said power source; a radio module configured to be in electrical communication with said electrical relay; a remote control device configured to be in radio communication with said radio module.

### TECHNICAL FIELD

The present invention relates to air horns used to provide warning sounds over wide distances.

### BACKGROUND OF THE INVENTION

Beyond the laughs and festivities, remote-controlled horn guns offer an unexpected layer of safety. In emergency situations, when attention is paramount, the horn guns become powerful tools for commanding focus. These devices can help prevent accidents, keep people aware, and ensure everyone's safety remains a priority. Horn guns are party essentials, icebreakers, attention-commanders, and guardians of safety.

U.S. Pat. No. 7,908,991B2 discloses a portable air horn apparatus which includes a housing, an air horn assembly for generating a warning sound, a switch for activating the air horn assembly and a power source. A microprocessor is provided in communication with the switch, the air horn assembly and the power source. The microprocessor includes at least one port for receiving an electronic component and is capable of automatically loading and executing software of the electronic component.

U.S. Pat. No. 8,004,390B2 describes an electromechanical horn which is configured with a body, a sound-generating unit mounted in the body, and a plurality of power source receiving regions for storing at least one removably mounted power source in a storage manner while containing a second power source in an operative manner thereby limiting discontinuity of the operation of the sound-generating unit.

U.S. Pat. No. 9,504,233B2 describes an electromechanical horn having a sound generating system including a piezoelectric speaker generates a series of short, audible sound signals in a repetitive pattern, the generated sound signals having fundamental frequencies with associated harmonic component frequencies and decibel levels that fall within a frequency range of greatest hearing sensitivity of the animal to disperse or deter an aggressive animal in a non-detrimental manner.

According to US2008258883A1, an electro-mechanical horn is configured with a body, a sound-generating unit mounted in the body, and a plurality of power source receiving regions for storing at least one removably mounted power source in a storage manner while containing a second power source in an operative manner thereby limiting discontinuity of the operation of the sound-generating unit.

Although all of the mentioned inventions are characterized by a certain portability, there is often a need for remote control of such devices—a function that the mentioned inventions do not offer to their users. In addition, the sound power of the cited devices is limited by the housings of those devices since the sound reproduction devices are embedded into the housings.

The purpose of the present invention is to create an apparatus providing the ability to expand the power of the device and providing its remote control to expand the scope of application of the device.

Further areas of applicability of the present disclosure will become apparent from the detailed description, the claims and the drawings. The detailed description and specific examples are intended for purposes of illustration only and are not intended to limit the scope of the disclosure.

### SUMMARY OF THE INVENTION

One aspect of the present invention provides a portable air horn apparatus.

According to a preferred embodiment of the invention, an apparatus includes a housing; an air horn assembly for generating a warning sound, said air horn being mounted on said housing and receiving a pressurized air from an air pump, said air pump being operable by an electric motor; a power source; a switch for selectively operating said electric motor using said power source; an electrical relay for selectively operating said electric motor using said power source; a radio module configured to be in electrical communication with said electrical relay; a remote control device configured to be in radio communication with said radio module.

Another aspect of the present invention provides a method for operating the portable air horn apparatus, said method includes the following steps:
receiving a radio signal by a radio module from a remote control device;
receiving an electrical signal by an electrical relay from the radio module;
closing an electrical circuit by the electrical relay;
receiving a power supply by an electric motor from a power source through the electrical circuit;
generating a pressurized air by an air pump being operable by the electric motor;
receiving the pressurized air by an air horn assembly from the air pump;
generating a warning sound by the air horn assembly being mounted on a housing of a portable air horn apparatus.

Various other purposes and advantages of the invention will become clear from its description in the specification that follows and from the novel features particularly pointed out in the appended claims. Therefore, to the accomplishment of the objectives described above, this invention consists of the features hereinafter illustrated in the drawings, fully described in the detailed description of the preferred embodiments and particularly pointed out in the claims. However, such drawings and description disclose only some of the various ways in which the invention may be practiced.

### BRIEF DESCRIPTION OF THE DRAWINGS

Other assemblies, systems, methods, apparatus, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 is a perspective view of a portable air horn apparatus.

FIG. 2 is a simplified electrical diagram of the apparatus.

### DETAILED DESCRIPTION OF THE INVENTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

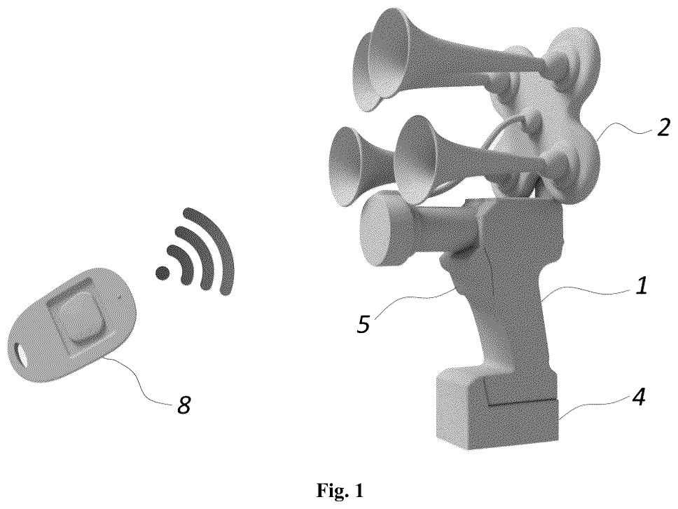

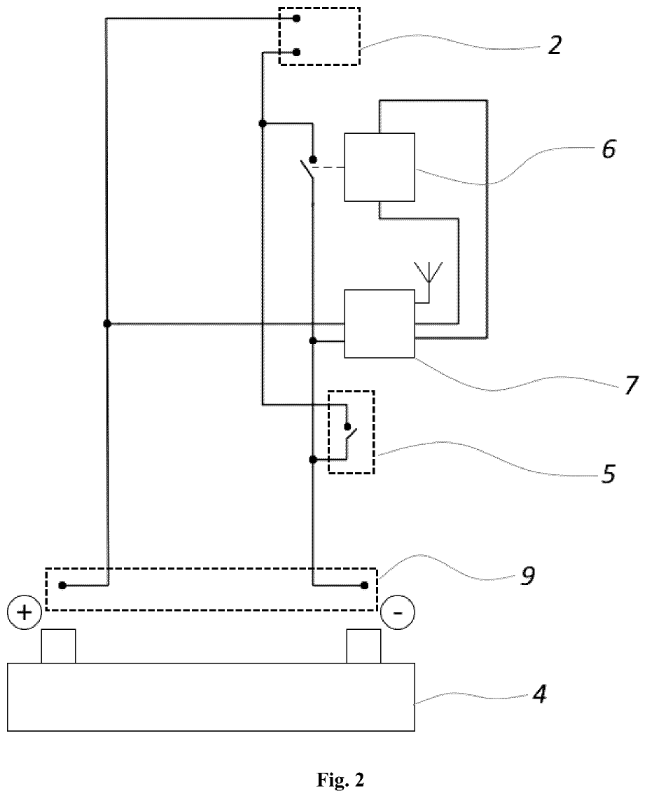

According to a preferred embodiment of the invention an apparatus includes a housing 1 (FIG. 1); an air horn assembly 2 (FIGS. 1 and 2) for generating a warning sound, said air horn being mounted on said housing and receiving a pressurized air from an air pump, said air pump being operable by a DC motor; a power source 4 (FIGS. 1 and 2) connected to the apparatus via an electrical connector 9; a switch 5 (FIGS. 1 and 2) for selectively operating said electric motor using said power source 4; an electrical relay 6 (FIG. 2) for selectively operating said electric motor using said power source; a radio module 7 (FIG. 2) configured to be in electrical communication with said electrical relay; a remote control device 8 (FIG. 1) configured to be in radio communication with said radio module. The air pump and the electric motor may be optionally embedded into the air horn assembly.

Positioning the air horn assembly outside the housing allows engineers to create devices of varying power and replace the item without disassembling the housing.

Another aspect of the present invention provides a method for operating the portable air horn apparatus, said method includes the following steps:
receiving a radio signal by the radio module 7 from a remote control device 8;
receiving an electrical signal by the electrical relay 6 from the radio module 7 (the radio module 7 is configured to selectively control the relay 6);
closing an electrical circuit by the electrical relay 6;
receiving a power supply by the electric motor from the power source 4 through the electrical circuit;
generating a pressurized air by the air pump being operable by the electric motor (when the motor rotor rotates, the pump rotor rotates and the pressurized air is created at the outlet of the pump);
receiving the pressurized air by the air horn assembly 2 from the air pump;
generating a warning sound by the air horn assembly 2 being mounted on the housing 1 of the portable air horn apparatus.

The method may additionally include closing the electrical circuit by the switch 5. Thus, the apparatus can be switched on either manually (as in the prior art) or remotely. In addition, remote control is especially useful if, due to the expansion of the apparatus power, its size increases significantly.

While only certain features and embodiments of the disclosure have been illustrated and described, many modifications and changes may occur to those skilled in the art without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosed embodiments. Furthermore, in an effort to provide a concise description of the exemplary embodiments, all features of an actual implementation may not have been described. It should be appreciated that in the development of any such actual implementation, as in any engineering or design project, numerous implementation-specific decisions may be made. Such a development effort might be complex and time-consuming, but would nevertheless be a routine undertaking of design, fabrication, and manufacture for those of ordinary skill having the benefit of this disclosure, without undue experimentation.

What is claimed is:

1. A portable air horn apparatus comprising:
a housing;
an air horn assembly for generating a warning sound, said air horn being mounted on said housing and receiving a pressurized air from an air pump, said air pump being operable by an electric motor;
a power source;
a switch for selectively operating said electric motor using said power source;
an electrical relay for selectively operating said electric motor using said power source;
a radio module configured to be in electrical communication with said electrical relay;
a remote control device configured to be in radio communication with said radio module.

2. The apparatus of claim 1, wherein the air horn assembly for generating a warning sound comprising the air pump and the electric motor.

3. A method, comprising:
receiving a radio signal by a radio module from a remote control device;
receiving an electrical signal by an electrical relay from the radio module;
closing an electrical circuit by the electrical relay;
receiving a power supply by an electric motor from a power source through the electrical circuit;
generating a pressurized air by an air pump being operable by the electric motor;
receiving the pressurized air by an air horn assembly from the air pump;
generating a warning sound by the air horn assembly being mounted on a housing of a portable air horn apparatus.

4. The method of claim 3, further comprising closing the electrical circuit by a switch.
